(19) United States
(12) Patent Application Publication
(10) Pub. No.: US 2014/0060363 A1
(43) Pub. Date: Mar. 6, 2014

(54) IMAGING MEMBER FOR OFFSET PRINTING APPLICATIONS

(71) Applicants: Matthew M. KELLY, West Henrietta, NY (US); David J. Gervasi, Pittsford, NY (US); Mandakini KANUNGO, Penfield, NY (US); Patrick J. HOWE, Fairport, NY (US); Maryna ORNATSKA, Hightstown, NJ (US); Santokh S. BADESHA, Pittsford, NY (US)

(72) Inventors: Matthew M. KELLY, West Henrietta, NY (US); David J. Gervasi, Pittsford, NY (US); Mandakini KANUNGO, Penfield, NY (US); Patrick J. HOWE, Fairport, NY (US); Maryna ORNATSKA, Hightstown, NJ (US); Santokh S. BADESHA, Pittsford, NY (US)

(73) Assignee: XEROX CORPORATION, Norwalk, CT (US)

(21) Appl. No.: 13/601,854

(22) Filed: Aug. 31, 2012

(51) Int. Cl. B41F 7/00; G02B 5/22; B28B 1/14

(52) U.S. Cl. 101/451; 264/299; 252/587

(57) ABSTRACT

An imaging member includes a surface layer comprising a silicone rubber and an infrared-absorbing filler. Methods of fabricating the imaging member and processes for variable lithographic printing using the imaging member are also disclosed.

The disclosure is related to U.S. patent application Ser. No. 13/095,714, filed on Apr. 27, 2011, titled “Variable Data Lithography System,” the disclosure of which is incorporated herein by reference in its entirety. The disclosure is related to co-pending U.S. patent application (Attorney Docket No. 056-0513), filed on the same day as the present disclosure, titled “Imaging Member for Offset Printing Applications,” the disclosure of which is incorporated herein by reference in its entirety; co-pending U.S. patent application (Attorney Docket No. 056-0512), filed on the same day as the present disclosure, titled “Imaging Member for Offset Printing Applications,” the disclosure of which is incorporated herein by reference in its entirety; co-pending U.S. patent application (Attorney Docket No. 056-0511), filed on the same day as the present disclosure, titled “Imaging Member for Offset Printing Applications,” the disclosure of which is incorporated herein by reference in its entirety; co-pending U.S. patent application (Attorney Docket No. 056-0510), filed on the same day as the present disclosure, titled “Imaging Member for Offset Printing Applications,” the disclosure of which is incorporated herein by reference in its entirety; co-pending U.S. patent application (Attorney Docket No. 056-0509, filed on the same day as the present disclosure, titled “Textured Imaging Member,” the disclosure of which is incorporated herein by reference in its entirety; co-pending U.S. patent application (Attorney Docket No. 056-0507), filed on the same day as the present disclosure, titled “Variable Lithographic Printing Process,” the disclosure of which is incorporated herein by reference in its entirety; co-pending U.S. patent application (Attorney Docket No. 056-0508), filed on the same day as the present disclosure, titled “Imaging Member for Offset Printing Applications,” the disclosure of which is incorporated herein by reference in its entirety; co-pending U.S. patent application (Attorney Docket No. 056-0505), filed on the same day as the present disclosure, titled “Printing Plates Doped With Release Oils,” the disclosure of which is incorporated herein by reference in its entirety; co-pending U.S. patent application (Attorney Docket No. 056-0504), filed on the same day as the present disclosure, titled “Imaging Member,” the disclosure of which is incorporated herein by reference in its entirety; and co-pending U.S. patent application (Attorney Docket No. 056-0451), filed on the same day as the present disclosure, titled “Methods and Systems for Ink-Based Digital Printing With Multi-Component, Multi-Functional Fountain Solution,” the disclosure of which is incorporated herein by reference in its entirety.

### BACKGROUND

1. Field of Disclosure

The present disclosure is related to imaging members having a surface layer as described herein. The imaging members are suitable for use in various marking and printing methods and systems, such as offset printing. The present disclosure permits methods and systems providing control of conditions local to the point of writing data to a reimageable surface in variable data lithographic systems. Methods of making and using such imaging members are also disclosed.

2. Background

Offset lithography is a common method of printing today. (For the purposes hereof, the terms “printing” and “marking” are interchangeable.) In a typical lithographic process a printing plate, which may be a flat plate, the surface of a cylinder, or belt, etc., is formed to have “image regions” formed of a hydrophobic/oleophilic material, and “non-image regions” formed of a hydrophilic/oleophobic material. The image regions correspond to the areas on the final print (i.e., the target substrate) that are occupied by a printing or marking material such as ink, whereas the non-image regions correspond to the areas on the final print that are not occupied by said marking material. The hydrophilic regions accept and are readily wetted by a water-based fluid, commonly referred to as a dampening fluid or fountain solution (typically consisting of water and a small amount of alcohol as well as other additives and/or surfactants to reduce surface tension). The hydrophobic regions repel dampening fluid and accept ink, whereas the dampening fluid formed over the hydrophilic regions forms a fluid “release layer” for rejecting ink. The hydrophilic regions of the printing plate thus correspond to unprinted areas, or “non-image areas”, of the final print.

The ink may be transferred directly to a target substrate, such as paper, or may be applied to an intermediate surface, such as an offset (or blanket) cylinder in an offset printing system. The offset cylinder is covered with a conformable coating or sleeve with a surface that can conform to the texture of the target substrate, which may have surface peak-to-valley depth somewhat greater than the surface peak-to-valley depth of the imaging plate. Also, the surface roughness of the offset blanket cylinder helps to deliver a more uniform layer of printing material to the target substrate free of defects such as mottle. Sufficient pressure is used to transfer the image from the offset cylinder to the target substrate. Pinching the target substrate between the offset cylinder and an impression cylinder provides this pressure.

Typical lithographic and offset printing techniques utilize plates which are permanently patterned, and are therefore useful only when printing a large number of copies of the same image (i.e. long print runs), such as magazines, newspapers, and the like. However, they do not permit creating and printing a new pattern from one page to the next without removing and replacing the print cylinder and/or the imaging plate (i.e., the technique cannot accommodate true high speed variable data printing wherein the image changes from impression to impression, for example, as in the case of digital printing systems). Furthermore, the cost of the permanently patterned imaging plates or cylinders is amortized over the number of copies. The cost per printed copy is therefore higher for shorter print runs of the same image than for longer print runs of the same image, as opposed to prints from digital printing systems.

Accordingly, a lithographic technique, referred to as variable data lithography, has been developed which uses a non-patterned reimageable surface that is initially uniformly coated with a dampening fluid layer. Regions of the dampening fluid are removed by exposure to a focused radiation source (e.g., a laser light source) to form pockets. A temporary pattern in the dampening fluid is thereby formed over the non-patterned reimageable surface. Ink applied thereover is retained in the pockets formed by the removal of the dampening fluid. The inked surface is then brought into contact with a substrate, and the ink transfers from the pockets in the dampening fluid layer to the substrate. The dampening fluid may then be removed, a new uniform layer of dampening fluid applied to the reimageable surface, and the process repeated.

It would be desirable to identify alternate materials that are suitable for use for imaging members in variable data lithography.

### BRIEF DESCRIPTION

The present disclosure relates to imaging members for digital offset printing applications. The imaging members have a surface layer made of a silicone rubber and a metal oxide filler.

Disclosed in embodiments is an imaging member comprising a surface layer. The surface layer comprises a silicone rubber and a infrared-absorbing filler.

In some embodiments, the silicone rubber is present in an amount of from about 80 to about 95 weight percent.

The infrared-absorbing filler may be present in an amount of from about 5 to about 20 weight percent. The infrared-absorbing filler may be iron oxide, graphene, graphite, or carbon nanotubes.

In some embodiments, the infrared-absorbing filler has an average particle size of from about 2 nanometers to about 10 microns.

Also disclosed in embodiments is a method of fabricating an imaging member surface layer. The method includes depositing a surface layer composition upon a mold; and curing the surface layer composition. The surface layer composition comprises a silicone material and a infrared-absorbing filler. The mold does not include a release layer.

The curing may occur at about room temperature.

In some embodiments, the surface layer composition further comprises a catalyst. The catalyst may be a platinum catalyst.

The infrared-absorbing filler may be present in an amount of from about 5 to about 20 weight percent

In some embodiments, the infrared-absorbing filler is iron oxide, graphene, graphite, or carbon nanotubes.

The infrared-absorbing filler may have an average particle size of from about 2 nanometers to about 10 microns.

The vulcanized surface layer may have a thickness of from about 0.5 microns to about 4 millimeters.

Further disclosed in embodiments is a process for variable lithographic printing. The process includes applying a fountain solution to an imaging member comprising an imaging member surface; forming a latent image by evaporating the fountain solution from selective locations on the imaging member surface to form hydrophobic non-image areas and hydrophilic image areas; developing the latent image by applying an ink composition to the hydrophilic image areas; and transferring the developed latent image to a receiving substrate. The imaging member surface comprises a silicone rubber and a infrared-absorbing filler.

In some embodiments, the fountain solution comprises a siloxane compound. The siloxane compound may be octamethylcyclotetrasiloxane.

The infrared-absorbing filler may comprise iron oxide, graphene, graphite, or carbon nanotubes. The infrared-absorbing filler may be present in an amount of from about 5 to about 20 weight percent.

In some embodiments, the infrared-absorbing filler has an average particle size of from about 2 nanometers to about 10 microns.

The silicone rubber may be present in an amount from about 80 to about 95 weight percent.

These and other non-limiting aspects and/or objects of the disclosure are more particularly described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

FIG. 1 illustrates a variable lithographic printing apparatus in which the dampening fluids of the present disclosure may be used.

FIG. 2 is a scanning electron micrograph (SEM) for the Agfa mold used to produce an imaging member surface layer.

FIG. 3 is the SEM for the Comparative Example produced using a Toray silicone.

FIG. 4 is the SEM for the RT 622 plate containing a silicone rubber and iron oxide filler.

FIG. 5 is a picture showing the Comparative Example after solid area development.

FIG. 6 is a picture showing the RT 622 plate after solid area development.

FIG. 7 is a picture showing the background of the Comparative Example.

FIG. 8 is a picture showing the background of the RT 622 plate.

FIG. 9 is a SEM of the surface of an RT 622 plate produced by casting.

FIG. 10 is a SEM of the surface of an RT 622 plate produced by solution coating.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The term “room temperature” refers to 25° C.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.”

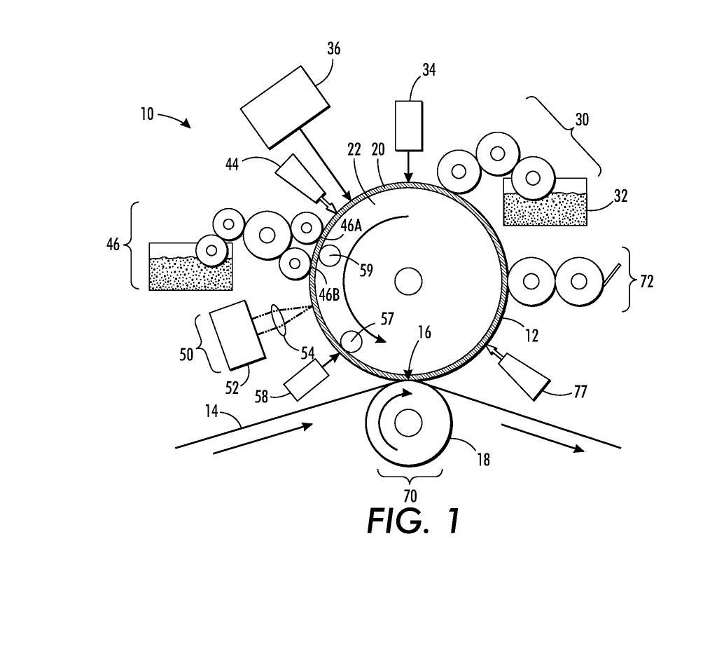

FIG. 1 illustrates a system for variable lithography in which the ink compositions of the present disclosure may be used. The system 10 comprises an imaging member 12. The imaging member comprises a substrate 22 and a reimageable surface layer 20. The surface layer is the outermost layer of the imaging member, i.e. the layer of the imaging member furthest from the substrate. As shown here, the substrate 22 is in the shape of a cylinder; however, the substrate may also be in a belt form, etc. Note that the surface layer is usually a different material compared to the substrate, as they serve different functions.

In the depicted embodiment the imaging member 12 rotates counterclockwise and starts with a clean surface. Disposed at a first location is a dampening fluid subsystem 30, which uniformly wets the surface with dampening fluid 32 to form a layer having a uniform and controlled thickness. Ideally the dampening fluid layer is between about 0.15 micrometers and about 1.0 micrometers in thickness, is uniform, and is without pinholes. As explained further below, the composition of the dampening fluid aids in leveling and layer thickness uniformity. A sensor 34, such as an in-situ non-contact laser gloss sensor or laser contrast sensor, is used to confirm the uniformity of the layer. Such a sensor can be used to automate the dampening fluid subsystem 30.

At optical patterning subsystem 36, the dampening fluid layer is exposed to an energy source (e.g. a laser) that selectively applies energy to portions of the layer to image-wise evaporate the dampening fluid and create a latent “negative” of the ink image that is desired to be printed on the receiving substrate. Image areas are created where ink is desired, and non-image areas are created where the dampening fluid remains. An optional air knife 44 is also shown here to control airflow over the surface layer 20 for the purpose of maintaining clean dry air supply, a controlled air temperature, and reducing dust contamination prior to inking. Next, an ink composition is applied to the imaging member using inker subsystem 46. Inker subsystem 46 may consist of a “keyless” system using an anilox roller to meter an offset ink composition onto one or more forming rollers 46A, 46B. The ink composition is applied to the image areas to form an ink image.

A rheology control subsystem 50 partially cures or tacks the ink image. This curing source may be, for example, an ultraviolet light emitting diode (UV-LED) 52, which can be focused as desired using optics 54. Another way of increasing the cohesion and viscosity employs cooling of the ink composition. This could be done, for example, by blowing cool air over the reimageable surface from jet 58 after the ink composition has been applied but before the ink composition is transferred to the final substrate. Alternatively, a heating element 59 could be used near the inker subsystem 46 to maintain a first temperature and a cooling element 57 could be used to maintain a cooler second temperature near the nip 16.

The ink image is then transferred to the target or receiving substrate 14 at transfer subsystem 70. This is accomplished by passing a recording medium or receiving substrate 14, such as paper, through the nip 16 between the impression roller 18 and the imaging member 12.

Finally, the imaging member should be cleaned of any residual ink or dampening fluid. Most of this residue can be easily removed quickly using an air knife 77 with sufficient air flow. Removal of any remaining ink can be accomplished at cleaning subsystem 72.

The imaging member surface generally has a tailored topology. Put another way the surface has a micro-roughened surface structure to help retain fountain solution/dampening fluid in the non-image areas. These hillocks and pits that make up the surface enhance the static or dynamic surface energy forces that attract the fountain solution to the surface. This reduces the tendency of the fountain solution to be forced away from the surface by roller nip action. The imaging member plays multiple roles in the variable data lithography printing process, which include: (1) wetting with the fountain solution, (2) creation of the latent image, (3) inking with the offset ink, and (4) enabling the ink to lift off and be transferred to the receiving substrate. Some desirable qualities for the imaging member, particularly its surface, include high tensile strength to increase the useful service lifetime of the imaging member. The surface layer should also weakly adhere to the ink, yet be wettable with the ink, to promote both uniform inking of image areas and to promote subsequent transfer of the ink from the surface to the receiving substrate. In addition, the imaging member surface layer is usually casted on a casting mold to obtain the desired topology. Some materials require the presence of a release layer (e.g. parylene or fluoropolymer) on the casting mold to easily separate the surface layer from the mold. It would be desirable if the imaging member surface did not require a release layer to be present on the casting mold, to decrease the cost and complexity of the fabrication process.

The imaging members of the present disclosure include a surface layer that meets these requirements. In particular, the surface layer 20 comprises a silicone rubber and a metal oxide filler. This allows the surface layer to efficiently absorb energy, which aids in dissipating fountain solution from the image areas in which ink is to be applied.

The term “silicone” is well understood in the arts and refers to polyorganosiloxanes having a backbone formed from silicon and oxygen atoms and sidechains containing carbon and hydrogen atoms. For the purposes of this application, the term “silicone” should also be understood to exclude siloxanes that contain fluorine atoms. Other functional groups may be present in the silicone rubber, for example vinyl, nitrogen-containing, mercapto, hydride, and silanol groups, which are used to link siloxane chains together during crosslinking. The sidechains of the polyorganosiloxane can be alkyl or aryl.

The term “alkyl” as used herein refers to a radical which is composed entirely of carbon atoms and hydrogen atoms which is fully saturated. The alkyl radical may be linear, branched, or cyclic. Linear alkyl radicals generally have the formula —CₙH₂ₙ₊₁.

The term “aryl” refers to an aromatic radical composed entirely of carbon atoms and hydrogen atoms. When aryl is described in connection with a numerical range of carbon atoms, it should not be construed as including substituted aromatic radicals. For example, the phrase “aryl containing from 6 to 10 carbon atoms” should be construed as referring to a phenyl group (6 carbon atoms) or a naphthyl group (10 carbon atoms) only, and should not be construed as including a methylphenyl group (7 carbon atoms).

Desirably, the silicone rubber is solution or dispersion coatable, which permits easy fabrication of the surface layer. In addition, the silicone rubber may be room temperature vulcanizable, or in other words uses a platinum catalyst for curing. In particular embodiments, the silicone rubber is a poly(dimethyl siloxane) containing functional groups such as vinyl or hydride that permit addition crosslinking. Such silicone rubbers are commercially available, for example as ELASTOSIL RT 622 from Wacker.

The silicone rubber is loaded with an infrared-absorbing filler that increases energy absorption. This aids in efficient evaporation of the fountain solution. In particular, it is contemplated that the energy is infra-red (IR) energy. In specific embodiments, the metal oxide filler is iron oxide (FeO). Other infrared-absorbing fillers include, but are not limited to, graphene, graphite, carbon nanotubes, and carbon fibers. The metal oxide filler may have an average particle size of from about 2 nanometers to about 10 microns.

The infrared-absorbing filler may make up from about 5 to about 20 weight percent of the surface layer, including from about 7 to about 15 weight percent. The silicone rubber may make up from about 80 to about 95 weight percent of the surface layer, including from about 85 to about 93 weight percent.

If desired, the surface layer may also include other fillers, such as silica. Silica can help increase the tensile strength of the surface layer and increase wear resistance. Silica may be present in an amount of from about 2 to about 30 weight percent of the surface layer, including from about 5 to about 30 weight percent. However, common carbon fillers with appreciable amounts of sulfur should not be used as fillers in addition to cured silicones, since these fillers have been found to inhibit the curing process of the silicone rubber.

The surface layer may have a thickness of from about 0.5 microns (μm) to about 4 millimeters (mm), depending on the requirements of the overall printing system.

Methods of fabricating the imaging member surface layer are also disclosed. The methods may include depositing a surface layer composition upon a mold; and curing the surface layer composition. The surface layer composition includes a silicone material and an infrared-absorbing filler. The mold does not require a release layer. The curing may be performed at room temperature. The curing may occur for a time period of from about 15 minutes to about 3 hours. The surface layer composition may further comprise a catalyst, such as a platinum catalyst.

Further disclosed are processes for variable lithographic printing. The processes include applying a fountain solution/dampening fluid to an imaging member comprising an imaging member surface. A latent image is formed by evaporating the fountain solution from selective locations on the imaging member surface to form hydrophobic non-image areas and hydrophilic image areas; developing the latent image by applying an ink composition to the hydrophilic image areas; and transferring the developed latent image to a receiving substrate. The imaging member surface comprises a silicone rubber and an infrared-absorbing filler.

The present disclosure contemplates a system where the dampening fluid is hydrophobic (i.e. non-aqueous) and the ink somewhat hydrophilic (having a small polar component). This system can be used with the imaging member surface layer of the present disclosure. Generally speaking, the variable lithographic system can be described as comprising an ink composition, a dampening fluid, and an imaging member surface layer, wherein the dampening fluid has a surface energy alpha-beta coordinate which is within the circle connecting the alpha-beta coordinates for the surface energy of the ink and the surface energy of the imaging member surface layer. In particular embodiments, the dampening fluid has a total surface tension greater than 10 dynes/cm and less than 75 dynes/cm with a polar component of less than 50 dynes/cm. In some embodiments, the dampening fluid has a total surface tension greater than 15 dynes/cm and less than 30 dynes/cm with a polar component of less than 5 dynes/cm. The imaging member surface layer may have a surface tension of less than 30 dynes/cm with a polar component of less than 2 dynes/cm.

By choosing the proper chemistry, it is possible to devise a system where both the ink and the dampening fluid will wet the imaging member surface, but the ink and the dampening fluid will not mutually wet each other. The system can also be designed so that it is energetically favorable for dampening fluid in the presence of ink residue to actually lift the ink residue off of the imaging member surface by having a higher affinity for wetting the surface in the presence of the ink. In other words, the dampening fluid could remove microscopic background defects (e.g. <1 μm radius) from propagating in subsequent prints.

The dampening fluid should have a slight positive spreading coefficient so that the dampening fluid wets the imaging member surface. The dampening fluid should also maintain a spreading coefficient in the presence of ink, or in other words the dampening fluid has a closer surface energy value to the imaging member surface than the ink does. This causes the imaging member surface to value wetting by the dampening fluid compared to the ink, and permits the dampening fluid to lift off any ink residue and reject ink from adhering to the surface where the laser has not removed dampening fluid. Next, the ink should wet the imaging member surface in air with a roughness enhancement factor (i.e. when no dampening fluid is present on the surface). It should be noted that the surface may have a roughness of less than 1 μm when the ink is applied at a thickness of 1 to 2 μm. Desirably, the dampening fluid does not wet the ink in the presence of air. In other words, fracture at the exit inking nip should occur where the ink and the dampening fluid interface, not within the dampening fluid itself. This way, dampening fluid will not tend to remain on the imaging member surface after ink has been transferred to a receiving substrate. Finally, it is also desirable that the ink and dampening fluid are chemically immiscible such that only emulsified mixtures can exist. Though the ink and the dampening fluid may have alpha-beta coordinates close together, often choosing the chemistry components with different levels of hydrogen bonding can reduce miscibility by increasing the difference in the Hanson solubility parameters.

The role of the dampening fluid is to provide selectivity in the imaging and transfer of ink to the receiving substrate. When an ink donor roll in the ink source of FIG. 1 contacts the dampening fluid layer, ink is only applied to areas on the imaging member that are dry, i.e. not covered with dampening fluid.

It is contemplated that the dampening fluid which is compatible with the ink compositions of the present disclosure is a volatile hydrofluoroether (HFE) liquid or a volatile silicone liquid. These classes of fluids provides advantages in the amount of energy needed to evaporate, desirable characteristics in the dispersive/polar surface tension design space, and the additional benefit of zero residue left behind once evaporated. The hydrofluoroether and silicone are liquids at room temperature, i.e. 25° C.

In specific embodiments, the volatile hydrofluoroether liquid has the structure of Formula (I):

CₘHₚF₂ₘ₊₁₋ₚ—O—CₙH_{q}F_{2n+1-q} Formula (I)

wherein m and n are independently integers from 1 to about 9; and p and q are independently integers from 0 to 19. As can be seen, generally the two groups bound to the oxygen atom are fluoroalkyl groups.

In particular embodiments, q is zero and p is non-zero. In these embodiments, the right-hand side of the compound of Formula (I) becomes a perfluoroalkyl group. In other embodiments, q is zero and p has a value of 2 m+1. In these embodiments, the right-hand side of the compound of Formula (I) is a perfluoroalkyl group and the left-hand side of the compound of Formula (I) is an alkyl group. In still other embodiments, both p and q are at least 1.

In this regard, the term “fluoroalkyl” as used herein refers to a radical which is composed entirely of carbon atoms and hydrogen atoms, in which one or more hydrogen atoms may be (i.e. are not necessarily) substituted with a fluorine atom, and which is fully saturated. The fluoroalkyl radical may be linear, branched, or cyclic. It should be noted that an alkyl group is a subset of fluoroalkyl groups.

The term “perfluoroalkyl” as used herein refers to a radical which is composed entirely of carbon atoms and fluorine atoms which is fully saturated and of the formula —CₙF₂ₙ₊₁. The perfluoroalkyl radical may be linear, branched, or cyclic. It should be noted that a perfluoroalkyl group is a subset of fluoroalkyl groups, and cannot be considered an alkyl group.

In particular embodiments, the hydrofluoroether has the structure of any one of Formulas (I-a) through (I-h):

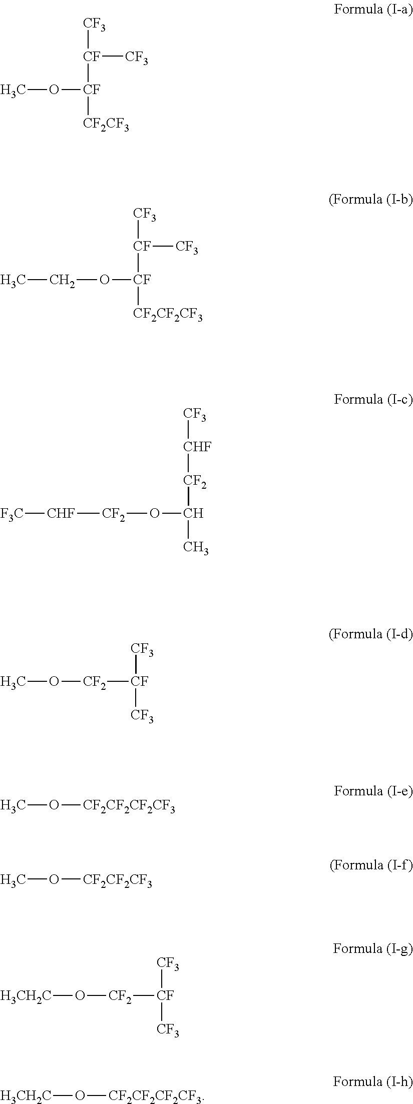

Of these formulas, Formulas (I-a), (I-b), (I-d), (I-e), (I-f), (I-g), and (I-h) have one alkyl group and one perfluoroalkyl group, either branched or linear. In some terminology, they are also called segregated hydrofluoroethers. Formula (I-c) contains two fluoroalkyl groups and is not considered a segregated hydrofluoroether.

Formula (I-a) is also known as 1,1,1,2,2,3,4,5,5,5-decafluoro-3-methoxy-4-(trifluoromethyl)pentane and has CAS#132182-92-4. It is commercially available as Novec™ 7300.

Formula (I-b) is also known as 3-ethoxy-1,1,1,2,3,4,4,5,5,6,6,6-dodecafluoro-2-(trifluoromethyl)hexane and has CAS#297730-93-9. It is commercially available as Novec™ 7500.

Formula (I-c) is also known as 1,1,1,2,3,3-Hexafluoro-4-(1,1,2,3,3,3-hexafluoropropoxy)pentane and has CAS#870778-34-0. It is commercially available as Novec™ 7600.

Formula (I-d) is also known as methyl nonafluoroisobutyl ether and has CAS#163702-08-7. Formula (I-e) is also known as methyl nonafluorobutyl ether and has CAS#163702-07-6. A mixture of Formulas (I-d) and (1-e) is commercially available as Novec™ 7100. These two isomers are inseparable and have essentially identical properties.

Formula (I-f) is also known as 1-methoxyheptafluoropropane or methyl perfluoropropyl ether, and has CAS#375-03-1. It is commercially available as Novec™ 7000.

Formula (I-g) is also known as ethyl nonafluoroisobutyl ether and has CAS#163702-05-4. Formula (I-h) is also known as ethyl nonafluorobutyl ether and has CAS#163702-06-5. A mixture of Formulas (I-g) and (1-h) is commercially available as Novec™ 7200 or Novec™ 8200. These two isomers are inseparable and have essentially identical properties.

It is also possible that similar compounds having a cyclic aromatic backbone with perfluoroalkyl sidechains can be used. In particular, compounds of Formula (A) are contemplated:

Ar—(CₖF₂ₖ₊₁)ₜ Formula (A)

wherein Ar is an aryl or heteroaryl group; k is an integer from 1 to about 9; and t indicates the number of perfluoroalkyl sidechains, t being from 1 to about 8.

The term “heteroaryl” refers to a cyclic radical composed of carbon atoms, hydrogen atoms, and a heteroatom within a ring of the radical, the cyclic radical being aromatic. The heteroatom may be nitrogen, sulfur, or oxygen. Exemplary heteroaryl groups include thienyl, pyridinyl, and quinolinyl. When heteroaryl is described in connection with a numerical range of carbon atoms, it should not be construed as including substituted heteroaromatic radicals. Note that heteroaryl groups are not a subset of aryl groups.

Hexafluoro-m-xylene (HFMX) and hexafluoro-p-xylene (HFPX) are specifically contemplated as being useful compounds of Formula (A) that can be used as low-cost dampening fluids. HFMX and HFPX are illustrated below as Formulas (A-a) and (A-b):

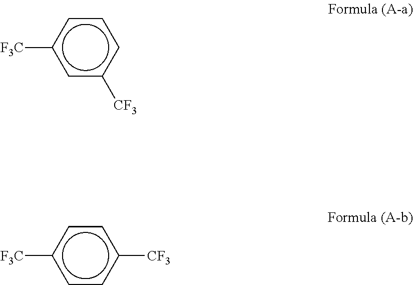

It should be noted any co-solvent combination of fluorinated damping fluids can be used to help suppress non-desirable characteristics such as a low flammability temperature.

Alternatively, the dampening fluid solvent is a volatile silicone liquid. In some embodiments, the volatile silicone liquid is a linear siloxane having the structure of Formula (II):

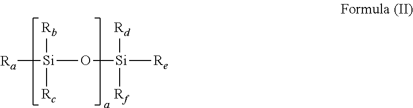

wherein Rₐ, R_{b}, R_{c}, R_{d}, Rₑ, and R_{f} are each independently hydrogen, alkyl, or perfluoroalkyl; and a is an integer from 1 to about 5. In some specific embodiments, Rₐ, R_{b}, R_{c}, R_{d}, Rₑ, and R_{f} are all alkyl. In more specific embodiments, they are all alkyl of the same length (i.e. same number of carbon atoms).

Exemplary compounds of Formula (II) include hexamethyldisiloxane and octamethyltrisiloxane, which are illustrated below as Formulas (II-a) and (II-b):

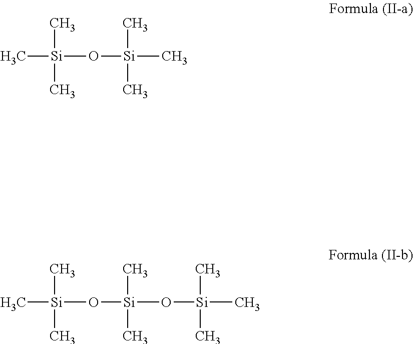

In other embodiments, the volatile silicone liquid is a cyclosiloxane having the structure of Formula (III):

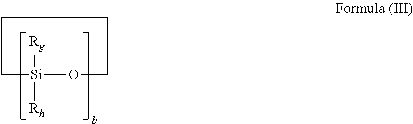

wherein each R_{g} and Rₕ is independently hydrogen, alkyl, or perfluoroalkyl; and b is an integer from 3 to about 8. In some specific embodiments, all of the R_{g} and Rₕ groups are alkyl. In more specific embodiments, they are all alkyl of the same length (i.e. same number of carbon atoms).

Exemplary compounds of Formula (III) include octamethylcyclotetrasiloxane (aka D4) and decamethylcyclopentasiloxane (aka D5), which are illustrated below as Formulas (III-a) and (III-b):

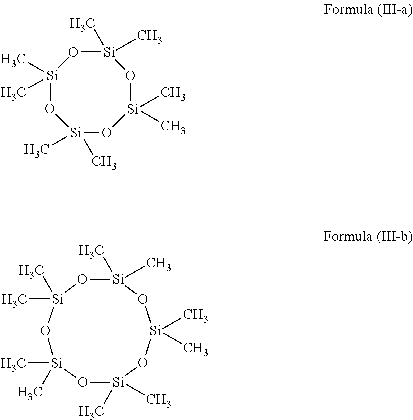

In other embodiments, the volatile silicone liquid is a branched siloxane having the structure of Formula (IV):

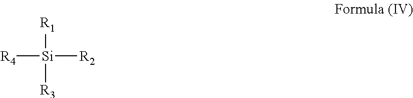

wherein R₁, R₂, R₃, and R₄ are independently alkyl or —OSiR₁R₂R₃.

An exemplary compound of Formula (IV) is methyl trimethicone, also known as methyltris(trimethylsiloxy)silane, which is commercially available as TMF-1.5 from Shin-Etsu, and shown below with the structure of Formula (IV-a):

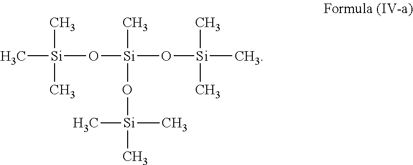 [SMILES: C[Si](C)(C)O[Si](C)(O[Si](C)(C)C)O[Si](C)(C)C]

Any of the above described hydrofluoroethers/perfluorinated compounds are miscible with each other. Any of the above described silicones are also miscible with each other. This allows for the tuning of the dampening fluid for optimal print performance or other characteristics, such as boiling point or flammability temperature. Combinations of these hydrofluoroether and silicone liquids are specifically contemplated as being within the scope of the present disclosure. It should also be noted that the silicones of Formulas (II), (Ill), and (IV) are not considered to be polymers, but rather discrete compounds whose exact formula can be known.

In particular embodiments, it is contemplated that the dampening fluid comprises a mixture of octamethylcyclotetrasiloxane (D4) and decamethylcyclopentasiloxane (D5). Most silicones are derived from D4 and D5, which are produced by the hydrolysis of the chlorosilanes produced in the Rochow process. The ratio of D4 to D5 that is distilled from the hydrolysate reaction is generally about 85% D4 to 15% D5 by weight, and this combination is an azeotrope.

In particular embodiments, it is contemplated that the dampening fluid comprises a mixture of octamethylcyclotetrasiloxane (D4) and hexamethylcyclotrisiloxane (D3), the D3 being present in an amount of up to 30% by total weight of the D3 and the D4. The effect of this mixture is to lower the effective boiling point for a thin layer of dampening fluid.

These volatile hydrofluoroether liquids and volatile silicone liquids have a low heat of vaporization, low surface tension, and good kinematic viscosity.

The ink compositions contemplated for use with the present disclosure generally include a colorant and a plurality of selected curable compounds. The curable compounds can be cured under ultraviolet (UV) light to fix the ink in place on the final receiving substrate. As used herein, the term “colorant” includes pigments, dyes, quantum dots, mixtures thereof, and the like. Dyes and pigments have specific advantages. Dyes have good solubility and dispersibility within the ink vehicle. Pigments have excellent thermal and light-fast performance. The colorant is present in the ink composition in any desired amount, and is typically present in an amount of from about 10 to about 40 weight percent (wt %), based on the total weight of the ink composition, or from about 20 to about 30 wt %. Various pigments and dyes are known in the art, and are commercially available from suppliers such as Clariant, BASF, and Ciba, to name just a few.

The ink compositions may have a viscosity of from about 5,000 to about 300,000 centipoise at 25° C. and a shear rate of 5 sec⁻¹, including a viscosity of from about 15,000 to about 250,000 cps. The ink compositions may have a viscosity of from about 2,000 to about 90,000 centipoise at 25° C. and a shear rate of 50 sec⁻¹, including a viscosity of from about 5,000 to about 65,000 cps. The shear thinning index, or SHI, is defined in the present disclosure as the ratio of the viscosity of the ink composition at two different shear rates, here 50 sec⁻¹ and 5 sec⁻¹. This may be abbreviated as SHI (50/5). The SHI (50/5) may be from about 0.10 to about 0.60 for the ink compositions of the present disclosure, including from about 0.35 to about 0.55. These ink compositions may also have a surface tension of at least about 25 dynes/cm at 25° C., including from about 25 dynes/cm to about 40 dynes/cm at 25° C. These ink compositions possess many desirable physical and chemical properties. They are compatible with the materials with which they will come into contact, such as the dampening fluid, the surface layer of the imaging member, and the final receiving substrate. They also have the requisite wetting and transfer properties. They can be UV-cured and fixed in place. They also have a good viscosity; conventional offset inks usually have a viscosity above 50,000 cps, which is too high to use with nozzle-based inkjet technology. In addition, one of the most difficult issues to overcome is the need for cleaning and waste handling between successive digital images to allow for digital imaging without ghosting of previous images. These inks are designed to enable very high transfer efficiency instead of ink splitting, thus overcoming many of the problems associated with cleaning and waste handling. The ink compositions of the present disclosure do not gel, whereas regular offset inks made by simple blending do gel and cannot be used due to phase separation.

Aspects of the present disclosure may be further understood by referring to the following examples. The examples are illustrative, and are not intended to be limiting embodiments thereof.

### EXAMPLES

### Example 1

RT 622 (commercially available from Wacker) is a two component silicone rubber that vulcanizes at room temperature. Part A comprises polydimethylsiloxane with functional groups. Part B comprises polydimethylsiloxane with functional groups and a platinum catalyst. The platinum catalyst serves as a curative agent for the silicone.

RT 622 was loaded into a ball milling jar with black iron oxide particles, a solvent, and a ball milling media. The material was tumble milled for a period of from 14 to 16 hours. The material was removed and a catalyst and an inhibitor were added. The material contained 10 wt % of black iron oxide (FeO). The material was then casted onto a textured Agfa mold (i.e. poured into a stationary mold) to form the imaging member plate. The imaging member plate had a smooth side and a rough side (i.e. microtextured).

As a Comparative Example, a corresponding plate was made using a silicone available from Toray. This plate contained 10 wt % of carbon black (CB). A release layer of AL233 (commercially available from Angstrom) was needed on the textured Agfa mold to ensure release.

The two plates (RT 622 and Comparative Example) were compared for surface morphology, then tested for surface texture, wetting, and ink release.

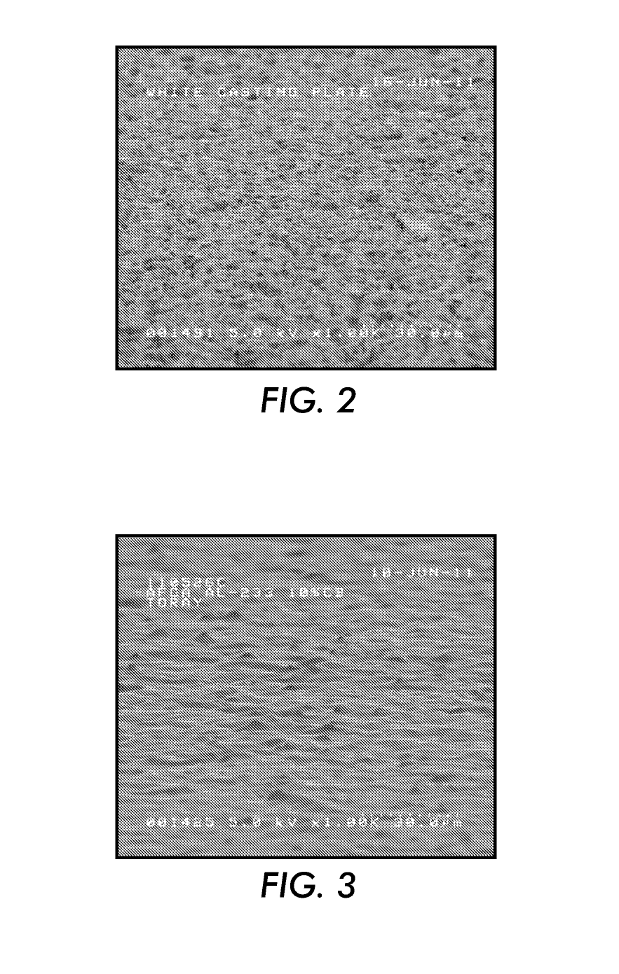

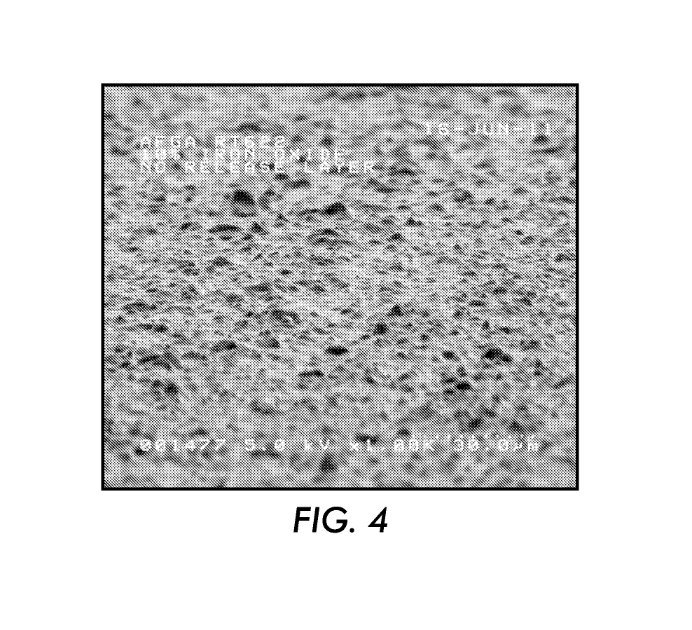

For surface morphology, the Agfa mold, the RT 622 plate, and the Comparative Examples were scanned using Scanning Electron Microscopy (SEM). FIG. 2 is the SEM for the Agfa mold. FIG. 3 is the SEM for the Comparative Example. FIG. 4 is the SEM for the RT 622 plate

Next, the static contact angle method was used to test the wetting of deionized water (DI) and NOVEC 7600 dampening fluid on both imaging plates on the smooth side and the rough side. The results are presented in Table 1 (below). “CA” is an abbreviation for contact angle. The margin of error is included in parentheses.

TABLE 1

| | | | | | CA of the |
|---|---|---|---|---|---|
| | | | CA of the | CA of the | rough side |
| Imaging | | Releasing | smooth | rough side | (Novec |
| plate | Filler | layer | side (DI) | (DI) | 7600) |
| Comparative | 10% | AL233 | 104.5 (1.5) | 121.8 (1.81) | 8.1 (1.1) |
| Example | CB | | | | |
| RT 622 | 10% | None | 106.5 (1.7) | 126.1 (2.1) | 3.6 (1.2) |
| | FeO | | | | |

The contact angle study indicated that DI water had a higher contact angle on the RT 622 plate on both sides when compared to the Comparative Example. These results indicated an increase in surface roughness in the case of RT 622 in comparison to the Comparative Example. In addition, the difference between the smooth side and the rough side was greater for the RT 622 plate, suggesting an increase in roughness enhancement for RT 622. Additionally, the NOVEC 7600 wetted the RT 622 plate better than the Comparative Example, as seen in the lower contact angle on the rough side. This indicated better uniform wetting.

Then, an inking and background study was carried out. The viscosities were modeled at 25° C. at a shear rate of 5 Hz or 50 Hz, and are reported in units of centipoise. The shear thinning index, or SHI, is the ratio of the viscosity of the ink composition at two different shear rates, here 50 Hz and 5 Hz. This may be abbreviated as SHI (50/5). Some properties of the ink are listed in Table 2:

TABLE 2

| | |
|---|---|
| Viscosity (5 Hz) | 64,525 |
| Viscosity (50 Hz) | 24,991 |
| SHI (50/5) | 0.39 |

NOVEC 7600 was used as the fountain solution.

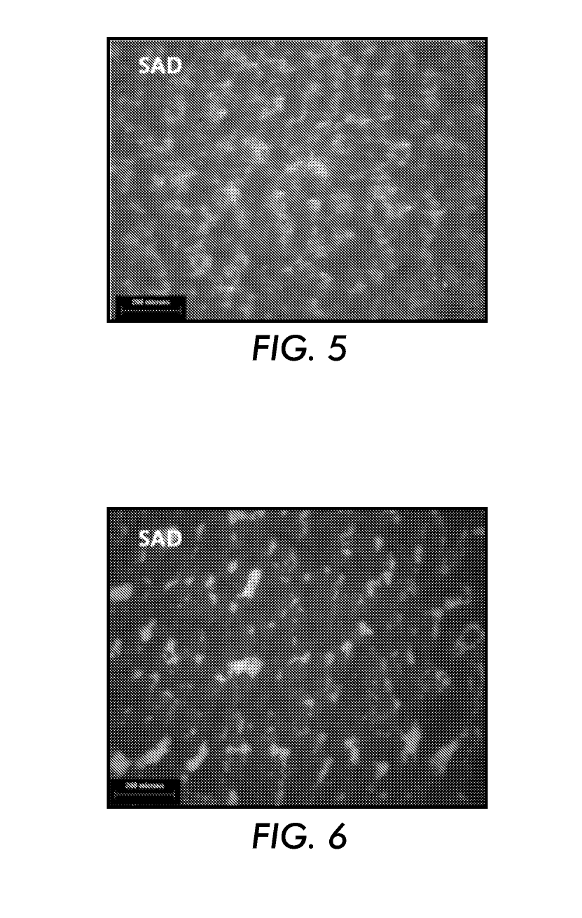

FIG. 5 is a picture showing the Comparative Example after solid area development (i.e. a 100% solid image print).

FIG. 6 is a picture showing the RT 622 plate after solid area development.

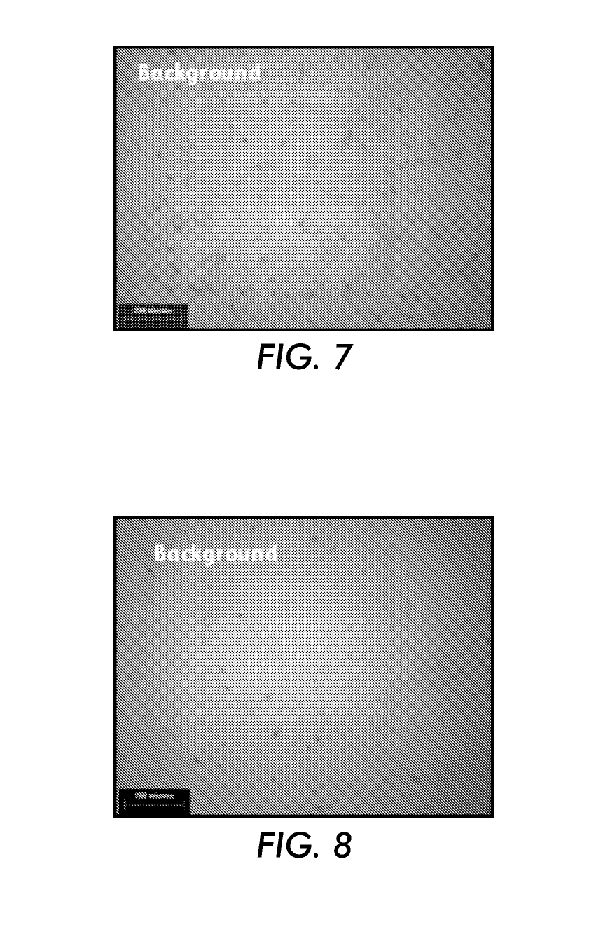

FIG. 7 is a picture showing the background of the Comparative Example (i.e. the non-image area).

FIG. 8 is a picture showing the background of the RT 622 plate.

The RT 622 plate exhibited better inking than the Comparative Example, as seen in standard solid area development (SAD) inking tests as shown in FIG. 5 and FIG. 6. SAD refers to a 100% solid image print whereas background refers to any ink in the non-image area. The backgrounds of the RT 622 plate and the Comparative Example were comparable as illustrated in FIGS. 7 and 8. Transfer efficiency between the two materials was comparable. Transfer efficiency is the measure of the quantity of ink that is transferred to the media (e.g. paper) divided by the total amount of ink applied to the image plate.

### Example 2

An RT 622 plate was produced via solution coating instead of casting, as in Example 1. Solution coating was carried out using a 12 inch by 36 inch Agfa plate. Solution coating was carried out by depositing the solution from a pumping system onto a rotating cylindrical surface.

The plate produced by casting (Example 1) was then compared to the plate produced by solution coating (Example 2). The results are shown in Table 3.

TABLE 3

| | | | | CA of the |
|---|---|---|---|---|
| | | | CA of the | rough side |
| Imaging | | Releasing | rough side | (Novec |
| plate | Filler | layer | (DI) | 7600) |
| Example 1 | 10% FeO | None | 126.1 (2.1) | 3.6 (1.2) |
| Example 2 | 10% FeO | None | 124.8 (2.6) | 5.1 (1.8) |

The contact angles were roughly the same, indicating that the fabrication method did not affect the properties of the resulting surface layer.

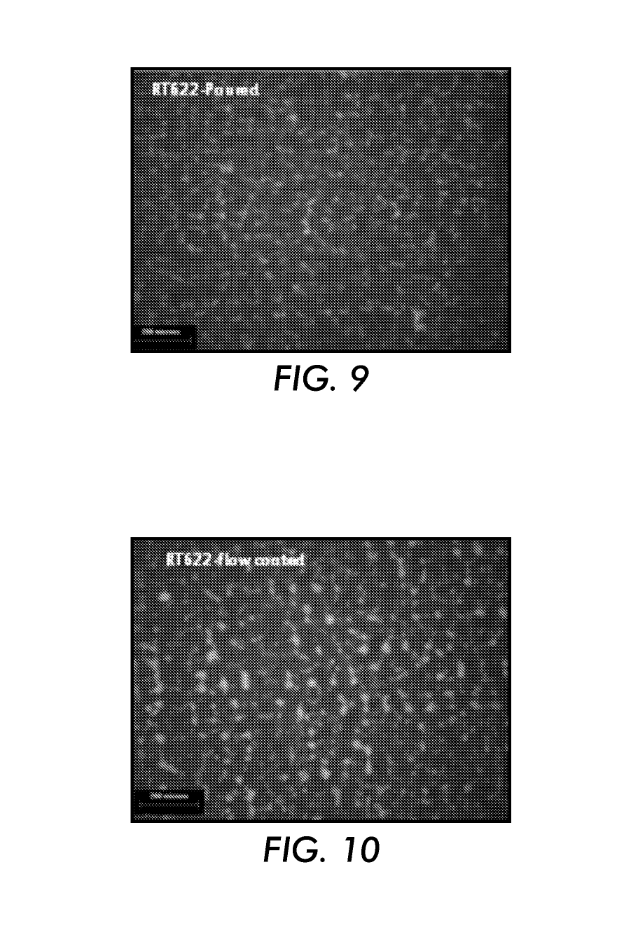

FIG. 9 is a SEM of the surface of the cast plate (Example 1). FIG. 10 is a SEM of the surface of the solution coated plate (Example 2). The plates of both examples exhibited good performance.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

What is claimed is:

1. An imaging member comprising a surface layer, wherein the surface layer comprises a silicone rubber and an infrared-absorbing filler.

2. The imaging member of claim 1, wherein the silicone rubber is present in an amount of from about 80 to about 95 weight percent.

3. The imaging member of claim 1, wherein the infrared-absorbing filler is present in an amount of from about 5 to about 20 weight percent.

4. The imaging member of claim 1, wherein the infrared-absorbing filler is iron oxide, graphene, graphite, or carbon nanotubes.

5. The imaging member of claim 1, wherein the infrared-absorbing filler has an average particle size of from about 2 nanometers to about 10 microns.

6. A method of fabricating an imaging member surface layer, comprising:
depositing a surface layer composition upon a mold; and
curing the surface layer composition;
wherein the surface layer composition comprises a silicone material and a infrared-absorbing filler; and
wherein the mold does not include a release layer.

7. The method of claim 6, wherein the curing occurs at about room temperature.

8. The method of claim 6, wherein the surface layer composition further comprises a catalyst.

9. The method of claim 8, wherein the catalyst is a platinum catalyst.

10. The method of claim 6, wherein the infrared-absorbing filler is present in an amount of from about 5 to about 20 weight percent

11. The method of claim 6, wherein the infrared-absorbing filler is iron oxide, graphene, graphite, or carbon nanotubes.

12. The method of claim 6, wherein the infrared-absorbing filler has an average particle size of from about 2 nanometers to about 10 microns.

13. The method of claim 6, wherein the vulcanized surface layer has a thickness of from about 0.5 microns to about 4 millimeters.

14. A process for variable lithographic printing, comprising:
applying a fountain solution to an imaging member comprising an imaging member surface;
forming a latent image by evaporating the fountain solution from selective locations on the imaging member surface to form hydrophobic non-image areas and hydrophilic image areas;
developing the latent image by applying an ink composition to the hydrophilic image areas; and
transferring the developed latent image to a receiving substrate;
wherein the imaging member surface comprises a silicone rubber and a infrared-absorbing filler.

15. The process of claim 14, wherein the fountain solution comprises a siloxane compound.

16. The process of claim 14, wherein the siloxane compound is octamethylcyclotetrasiloxane.

17. The process of claim 14, wherein the infrared-absorbing filler comprises iron oxide, graphene, graphite, or carbon nanotubes.

18. The process of claim 14, wherein the infrared-absorbing filler is present in an amount of from about 5 to about 20 weight percent.

19. The process of claim 14, wherein the infrared-absorbing filler has an average particle size of from about 2 nanometers to about 10 microns

20. The process of claim 14, wherein the silicone rubber is present in an amount from about 80 to about 95 weight percent.
